(19) United States
(12) Patent Application Publication
(10) Pub. No.: US 2009/0235352 A1
(43) Pub. Date: Sep. 17, 2009

(54) SYSTEM AND METHOD FOR APPLICATION MANAGEMENT ON MULTI-APPLICATION SMART CARDS

(75) Inventors: Geert Jan Schrijen, Eindhoven (NL); Lutz Pape, Hamburg (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/721,157

(22) PCT Filed: Dec. 2, 2005
(86) PCT No.: PCT/IB05/54015

§ 371 Date: Jul. 31, 2007

(30) Foreign Application Priority Data
Dec. 7, 2004 (EP) 04106353.8

(51) Int. Cl. H04L 9/32; G06F 12/14; G06K 19/06

(52) U.S. Cl. 726/18; 235/492

(57) ABSTRACT

In order to provide a management system (100) as well as a method for managing at least one installation right (40a) to install at least one application (46, 42) on a smart card (300), in particular on a multi-application smart card, wherein it is possible that at least one first party or first unit (10) controlling the application(s), in particular on the smart card (300), in particular the smart card issuer, is able to transfer (44) this control to at least one second party or second unit (20), it is proposed that the management system (100) is designed to manage said installation right (40a), in particular on the smart card (300), insofar as the role of authorizing (22) at least one third party or third unit (30), in particular at least one third party application provider, to exert said installation right (40a), in particular to install its application (42) on the smart card (300), can be transferred (44) from at least one first party or first unit (10), in particular from the issuer of the smart card (300), to at least one second party or second unit (20).

The present invention relates to a management system as well as to a method for managing at least one installation right to install at least one application on a smart card, in particular on a multi-application smart card.

In prior art document WO 97/10562 A1, a programming interface for a smart card kiosk is disclosed. In more detail, prior art document WO 97/10562 A1 describes some kiosk at which application providers or vendors can install their software to do transactions with users owning smart cards. The kiosk provides a standard interface for these applications so that transactions can be done and data structures on the card can be updated regardless of the type of smart card owned by the user. However, this programming interface does not relate to the delegation of management for applications on the smart cards.

A method of securely loading command in a smart card, in particular a basic technology for certifying applications or commands which have to be loaded or executed on a smart card is disclosed in prior art document EP 0 798 673 A1 where two parties both have to agree on which applications are allowed to run on the smart card. In particular, prior art document EP 0 798 673 A1 describes how a command and/or an application can be securely loaded onto a smart card by first letting two independent parties, for example the card issuer and a trusted third party, approve such command and generate an authentication code. These two parties both have a secret key being also known in the smart card, such that the smart card can check whether the command or application was indeed approved by these parties before executing the command. However, prior art document EP 0 798 673 A1 does not discuss the functionality of having one party controlling the application(s) on the smart card and later on being able to transfer this control to a second party.

In prior art document WO 98/43212 A1, a post-issuance download of an application onto a smart card is disclosed. In particular, the described method allows card issuers to add applications after issuance of the smart card, in particular during lifetime. Applications can be installed via a second application, called a card-domain. Thus, the basic functionality of so-called S[ecurity]D[omains] also specified in a G[lobal]P[latform]/O[pen]P[latform] standard is described. However, prior art document WO 98/43212 A1 does not discuss the possibility of delegated management, i.e. letting anyone else than the card issuer install applications after issuance. Furthermore, prior art document WO 98/43212 A1 does not relate to transferring management of applications which may be installed on the card.

How delegated management is performed within the GlobalPlatform/OpenPlatform standard is described in prior art document US 2002/0040936 A1. Delegated management means that application providers can install their own application on a smart card after issuance, without requiring the card issuer to be online; in contrast thereto, in earlier smart card systems adding of applications could only be done by the issuer.

However, in delegated management an application from a third party application provider first needs to be approved by the card issuer. The card issuer generates a so-called data authentication pattern for the new application, which the smart card can check later on. So in this case the card issuer still has control over which applications may be installed onto the smart card.

The G[lobal]P[latform] specifications (cf. GlobalPlatform Consortium, Card Specification, Version 2.1.1., March 2003, available at http://www.globalplatform.org/) define an architecture and standard for dynamic multi-application smart cards. Their goal is to provide vendor- and hardware-independent interfaces to applications and off-card management systems. The GlobalPlatform standard is currently the only known (and hence most progressive) standard specifying such a multi-application card management system.

In G[lobal]P[latform], the card issuer has the most powerful control concerning the application management on the smart card. The card issuer has master keys to the card manager on the smart card, with which load operations, install operations and delete operations can be performed.

The GP allows other application providers to obtain keys of on-card S[ecurity]D[omains]. A security domain is a special kind of application providing security services like key handling, encryption, decryption, etc. to its owner and can be used by application providers to load and to install new applications onto the smart card. Applications are associated to the security domain of an application provider. The application provider, who owns S[ecurity]D[omain] keys, can setup a secure channel to the security domain and install its applications if they are pre-approved by the card issuer. This is referred to as delegated management within G[lobal]P[latform].

Before an application can be installed, the application provider must obtain an installation token from the card issuer. This token, i.e. the pre-authorization, uniquely identifies the subject application code with its allowed privileges and is digitally signed by the card issuer. The security domain passes this token to the card manager, who verifies this token and performs the actual installation of the applet or application. The application provider is allowed to delete applications being associated to its security domain.

The GlobalPlatform standard furthermore allows another entity than the card issuer to co-decide which applications may be installed onto the card. This entity is called the C[ontrolling]A[uthority] within G[lobal]P[latform]. The on-card representative of the CA is a special security domain, called the C[ontrolling]A[uthority] S [ecurity]D[omain].

If a CASD is present on the smart card, new applications must additionally be accompanied by a load file signature from the CA before they can be installed. So an application being installed via delegated management, in particular via an application provider SD, has to be accompanied with both a load and/or install token from the issuer and a signature on the application code from the CA. Hence, both the issuer and the controlling authority must approve an application before this application can be installed onto the smart card.

Although the G[lobal]P[latform] specifications provide a progressive way of dealing with card management on multi-application smart cards, the GP system also has its limitations. For example, GP does not support the scenario in which a payment organization installs its application and takes over the application management function. Application management means controlling which applications may be installed on a smart card.

Furthermore, GP does not allow flexible rights enabling an application provider to install any code wanted. Such an application-independent installation right could be useful in the case that the card issuer does not want to issue new installation rights for every single application (which might be a cumbersome task if a large number of application providers all have multiple versions of their application code which they want to install).

An application-independent installation right could for example be issued to an application provider if both parties have made an agreement stating that the application provider will not install harmful code. So correct behaviour of third party applets is enforced in a legal way.

Starting from the disadvantages and shortcomings as described above and taking the prior art as discussed into account, an object of the present invention is to further develop a management system of the kind as described in the technical field and a method of the kind as described in the technical field in such way that at least one first party or first unit controlling the application(s) on a smart card, in particular the smart card issuer, is able to transfer this control to at least one second party or second unit.

The object of the present invention is achieved by a management system comprising the features of claim 1 as well as by a method comprising the features of claim 12. Advantageous embodiments and expedient improvements of the present invention are disclosed in the claims being dependent on claim 1.

The present invention is principally based on the idea of transferable application management, i.e. comprises the functionality of having one unit or party controlling the application(s) on a smart card and later on being able to transfer this control to at least one second unit or party.

Thus, the management system according to the present invention deals with application management in a much more flexible way than conventional management systems insofar as the control over which applications may be installed onto the smart card is transferred from the first party or first unit to the second party or second unit. The first party or first unit, in particular the smart card issuer, allows for example certain parties to take over complete control about which applications may be installed on the smart card.

According to a preferred embodiment of the present invention this way of application management can be achieved by letting the first party or first unit provide at least one installation right in the form of at least one digital certificate (digital certificates are explained in more detail in the chapter “Brief explanation of the drawings” below).

Advantageously, upon installation of a new application, these installation rights are checked by the management system or card manager which is the on-card representative of the first party or first unit, in particular the on-card representative of the card issuer.

Furthermore, according to an expedient embodiment it is proposed to implement a special kind of at least one application slot for installing at least one management enabling application, for example at least one payment application. This leads to the advantage that the second unit, for example a payment organization, can install its management enabling application, for example its payment applet, if the second unit has obtained the appropriate installation rights from the first party or first unit.

As soon as this management enabling application is installed, the management system, in particular the card manager, enforces that the public key of this second unit will be used to verify installation rights instead of the public key of the first party or first unit.

Moreover, according to a preferred embodiment, as soon as the management enabling application is deleted, the management system sets the installation right verification key back to the public key of the first party or first unit.

The ability to take over the application management is for example useful in situations where
a second unit installs an important application on the smart card of which abuse must be prevented and
liability of smart card transactions shifts to the second unit.

In that case the second unit desires increased control on which other applications may be installed on the smart card. This feature may be exemplified by the following situation:

A payment organization becomes liable for financial transactions with the smart card as soon as its management enabling application is installed onto the card. The payment organization wants to control which other applications may be installed in order to prevent possibly harmful code (that could abuse the payment applet) from entering the smart card.

In conventional systems as GlobalPlatform/OpenPlatform it is possible to activate a controlling authority which must provide a signature before a certain application can be installed onto the smart card. However, still a load token and/or install token from the issuer is required as well; so it is merely an extra right that an application provider has to obtain.

In contrast thereto, the present invention allows to completely transfer the application management to the controlling authority which can be the payment organization. In conventional card management systems, the payment organization is usually the card issuer having control over the smart card. The present invention allows a card issuer to issue smart cards independently of a second unit, for example independently of a payment organization.

Moreover, according to a preferred embodiment of the present invention the second unit can install its management enabling application at a later point in time, even after other third party applications have been installed. In that case the second unit needs to be able to check which other application(s) is (are) already present on the smart card.

According to an advantageous embodiment either the second unit can retrieve application identifier(s) and application provider identifier(s), which the second unit can check for example by way of at least one central server, or the second unit can read the exact application code of the installed applet(s) or application(s). This option is preferably provided by the management system and optionally supported by an underlying operating system.

If the second unit finds third party applications on the smart card which the second unit does not trust, the second unit will not install for example its payment applet. In such a case, according to a preferred embodiment the second unit can initiate at least one delete request for application(s) already present on the smart card, in particular for the untrusted application(s). However, according to an advantageous refinement of the present invention, first party or first unit application(s) can only be deleted by the first party or first unit.

According to a further preferred embodiment of the present invention
the smart card first party or first unit and/or
the smart card second party or second unit and/or
the smart card third party or third unit and/or
at least one smart card further party or further unit

is (are) allowed to delete and/or to uninstall at least one application being present on the smart card, wherein optionally this action of deleting and/or of uninstalling has to be confirmed by the user.

In a user perspective it is preferable to give the user the power to decide which applications are available on his or her smart card. Therefore it is proposed according to an advantageous embodiment of the present invention to let all card changes, in particular any installation or any deletion taking place on the smart card, be confirmed by the user.

Moreover, according to a preferred embodiment of the present invention the management system arranges the confirmation by the user by sending at least one confirmation request to the user upon requested card change(s). Such a request is preferably sent via at least one smart card reader device to at least one host terminal of the user.

According to an advantageous embodiment the user can for example confirm a card change
by pressing at least one button or key on the host terminal and/or
by entering its P[ersonal]I[dentification]N[umber] and/or
by identifying via at least one biometric feature.

The latter form is more secure because only the intended user can execute this action.

The present invention further relates to an integrated circuit, comprising at least one management system as described above and/or being operated according to the method as described above.

Moreover, the present invention further relates to a smart card, in particular to a multi-application smart card, comprising at least one I[ntegrated]C[ircuit] as described above.

The present invention finally relates to the use of at least one management system as described above and/or of at least one integrated circuit as described above and/or of the method as described above for flexible and transferable application management on multi-application smart cards as described above.

As already discussed above, there are several options to embody as well as to improve the teaching of the present invention in an advantageous manner. To this aim, reference is made to the claims dependent on claim 1; further improvements, features and advantages of the present invention are explained below in more detail with reference to a preferred embodiment by way of example and to the accompanying drawing where

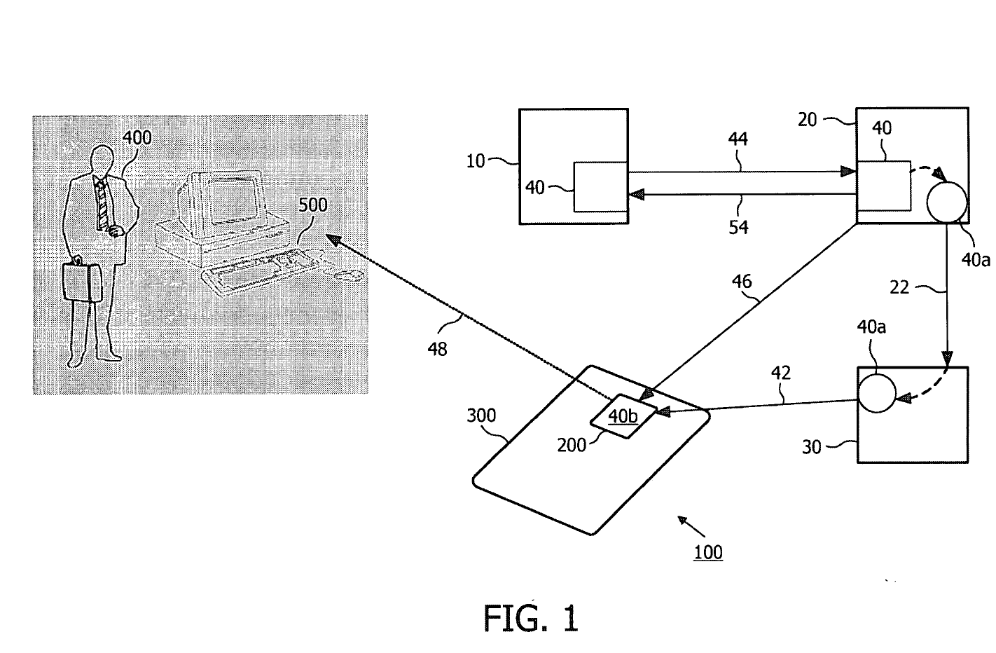

FIG. 1 schematically shows an embodiment of a management system according to the present invention and working according to the method of the present invention.

The exemplified embodiment of the present invention starts from the problem that conventional multi-application smart cards employ card management systems enabling the card issuer 10 to control which applications may be installed on a user's 400 smart card. However, such systems are not flexible enough to support business models in which another (authorized) party must be able to take over the application management function.

Such functionality is desirable in situations where for example payment organizations install their payment applet on a smart card 300 and become liable for financial transactions with this smart card 300. In this case the payment organization 20 wants to control which other applications 42 are allowed to run besides their payment application 46, so that possibly harmful code can be fenced.

According to the present invention a flexible card management system 100 based on certificates 40b in order to enable such a business model is proposed. FIG. 1 depicts a first embodiment of such management system 100 for flexible and transferable application management on a multi-application smart card 300 as well as an integrated circuit 200 being arranged on the smart card 300 and comprising the management system 100.

A first party or first unit, namely a smart card issuer 10 issues one or more installation rights 40a to other parties 20, 30, in particular
to a second party or second unit, namely to a payment organization 20, and
to a third party or third unit, namely to a third party application provider 30.

In the exemplifying case of FIG. 1, the smart card issuer 10 issues said installation right 40a to the payment organization 20. The payment organization 20 can then present this installation right 40a to the smart card 300 where the card management system (so-called card manager 100) can interpret and verify the right; by way of such interpreting and verifying, a management enabling application, namely a payment application 46, is allowed to be installed on the smart card 300.

The management system 100 is designed to manage said installation rights 40a with respect to the smart card 300 insofar as the role of authorizing (cf. reference numeral 22 in FIG. 1) one or more application providers 30 to install their respective application(s) 42 on the smart card 300 can be transferred (cf. reference numeral 44 in FIG. 1) from the smart card issuer 10 to the payment organization 20.

This transfer 44 of application management 40 can be taken from FIG. 1 insofar as an installation right 40a has not remained with the smart card issuer 10 but has gone from this smart card issuer 10 to the payment organization 20. Consequently, this payment organization 20 now being responsible for the application management 40 may authorize (cf. reference numeral 22 in FIG. 1) the third party application provider 30 to exert this installation right 40a.

In this context, the role of application management 40 is transferred from the smart card issuer 10 to the payment organization 20 as soon as the payment applet 46 is installed onto the smart card 300 by said payment organization 20. Thus, after the payment organization 20 having installed its payment application 46, the payment organization 20 can issue (cf. reference numeral 22 in FIG. 1) the installation right 40a to the third party or application provider 30. The application provider 30 can present said installation right 40a to the smart card 300 in order to get its application 42 installed.

As soon as the management enabling application 46 is deleted and/or uninstalled from the smart card 300, the role of application management 40 falls back (cf. reference numeral 54 in FIG. 1) from the payment organization 20 to the card issuer 10, for instance for reasons of security and/or for reasons of control of card application management 40.

The management system 100 supports application-dependent as well as application-independent installation rights 40a, wherein the installation rights 40a are implemented or represented on the smart card 300 in the form of digital certificates 40b being provided by the smart card issuer 10. In the following, it is described how flexible installation rights 40a can be created with such digital certificates.

Basically, a digital certificate 40b is a message or statement, which is provided with a digital signature from the author. The signer typically creates such a digital signature by encrypting a hash of the total message with its private key. Anyone can verify this signature by using the public key of the signer to retrieve the contained hash value and compare this hash value with a self-generated hash value of the message (for a more detailed introduction to digital certificates see B. Schneier, Applied Cryptography, second edition, John Wiley & Sons Inc, 1996).

According to the present invention the installation right 40a used for authorizing the installation of applications 42, 46 onto the smart card 300 is created by defining a digital certificate 40b having certain fields in the following way:

C[d_{AM}]{Type,Date,Valid,e_{AM},AppID,CodeID,e_{AP},Target,Options} (1)

This construction denotes a certificate 40b, which is signed with the private key d_{AM} of the application manager which can either be the card issuer 10 or the payment organization 20; this certificate 40b has the following fields:
Type: indicates the type of certificate; Type indicates whether it concerns an installation right 40a for a third party application provider (for example Type=IR), or an installation right 40a for a payment organization (for example Type=Pay);
Date: indicates the date of issuance of the certificate;
Valid: indicates until when or during which time interval the certificate is valid;

e_{AM}: indicates the public key of the application manager 10, 20 being the issuer of the certificate; so this key can be used to verify the signature on the certificate;
AppID: indicates a unique identifier of the application 42, 46 to be installed; this value can also be used to indicate that it concerns an application-independent installation right (for example AppID=0);
CodeID: indicates an identifier identifying the code of the application 42, 46 to be installed; preferably the CodeID is generated by applying a hash function to the application code;
e_{AP}: indicates the public key of the application provider 20 or 30; it can be used to setup a secure channel between application provider 20 or 30 and card manager or management system 100;
Target: indicates to which smart cards 300 the installation right 40a applies; a set of smart card identification numbers can be indicated here; alternatively, it can be indicated that the installation right 40a is valid for all smart cards 300 (Target=All);
Options: reserved to indicate several other certificate options; information concerning the revocation of certificates (for example the name of an online revocation server) can for example be taken up in this field Options.

In the following, some examples of installation rights 40a being providable in the flexible card management system 100 are given.

First, some examples for installation rights for third party application(s) are explained:

An installation right 40a allowing a third party application provider 30 with public key e_{AP1}, to install an application 42 with application identifier AP1A1 looks like this:

C[d_{Issuer}]{Type=IR,Date=May, 10, 2003,Valid=till 2004,e_{AM}=e_{Issuer},AppID=AP1A1,

CodeID=28264465271182,e_{AP}=e_{AP1},Target=(014423-014520),Options} (2)

The installation right 40a is issued by the card issuer 10 and enables installation on the smart cards 300 with serial numbers 014423 to 014520 which have no payment application 46 installed. If for example one of these smart cards 300 has a VISA® payment applet, then VISA® (in its function as payment organization 20) has to sign such installation right 40a, and a possible certificate could be:

C[d_{VISA}]{Type=IR,Date=May 10, 2003,Valid=1 year,e_{AM}=e_{VISA},

AppID=AP1A1,CodeID=28264465271182,e_{AP}=e_{AP1},Target=All,Options} (3)

Such a installation right 40a could be made application-independent by omitting the specification of the application identifier and code identifiers. This is exemplified in the following certificate:

C[d_{VISA}]{Type=IR,Date=May 10, 2003,Valid=1 year,e_{AM}=e_{VISA},

AppID=0,CodeID=0,e_{AP}=e_{AP1},Target=All,Options} (4)

In the following, an example for an installation right 40a for payment application 46 is given:

The card issuer 10 can generate special installation rights 40a allowing payment organizations 20 to install their payment applet 46 and take over (cf. reference numeral 44) application management on this smart card 300. In the following example, VISA® (identified by the public key e_{VISA}) is given the right 40a to install payment applets 46 and become application manager:

C[d_{Issuer}]{(Type=Pay,Date=Feb. 8, 2003,Valid=till 2005,e_{AM}=e_{Issuer},

AppID=0,CodeID=0,e_{AP}=e_{VISA},Target=All,Options} (5)

Upon receiving this installation right 40a, the card manager checks the signature from the card issuer 10 (of which the card manager knows the public key) and sets up a S[ecure]A[uthenticated]C[hannel] with the payment organization 20. The public key e_{VISA} being indicated in the certificate is used for setting up such SAC. Over this SAC, VISA® can install its payment application 46 and communicate a public key to the card manager which must from then on be used to verify the installation rights 40a. Alternatively, the public key e_{VISA} is used for this purpose.

The management system or card manager 100 on the smart card 300 can verify the certificates because it knows the public key e_{Issuer} of the card issuer 10. Certificates signed with the private key d_{Issuer} of the issuer 10 can hence be checked. The right 40a presented above allows the payment organization 20 to install its application 46. From that point in time, the card manager 100 stores the public key of the payment organization 20 (e_{VISA} in this example) into its memory.

This public key can now be used to check installation rights 40a issued by VISA®, like the rights with the label (2) and (3) explained above. As soon as the VISA® applet is removed, the card manager 100 deletes the public key e_{VISA} and from that point checks installation rights 40a again with the public key e_{Issuer} of the card issuer 10.

Any such deletion or installation taking place on the smart card 300 needs to be confirmed by the user 400 of the smart card 300. For this aim, the management system 100 sends a confirmation request 48 to a host terminal 500 of the user 400 of the smart card 300.

### LIST OF REFERENCE NUMERALS

100 card manager or card management system
10 first party or first unit controlling at least one application on the smart card 300, in particular issuer of the smart card 300
20 second party or second unit, in particular payment organization
22 authorization of the third party or third unit 30 to install its application 42 on the smart card 300,
   in particular issuing the installation right 40a to the third party or third unit 30
30 third party or third unit, in particular third party application provider
40 application management
40a installation right
40b digital certificate, in particular representing the installation right 40a on the smart card 300
42 application, in particular application of the third party or third unit 30
44 transfer of the role of authorization 22 and/or of the role of application management 40 from the first party or first unit 10 to the second party or second unit 20
46 management enabling application, in particular payment application
48 confirmation request
54 falling back of the role of authorization 22 and/or of the role of application management 40 from the second party or second unit 20 to the first party or first unit 10
200 integrated circuit
300 smart card, in particular multi-application smart card
400 user
500 host terminal

1. A management system for managing at least one installation right to install at least one application on a smart card, in particular on a multi-application smart card, characterized by being designed to manage said installation right, in particular on the smart card, insofar as the role of authorizing at least one third party or third unit, in particular at least one third party application provider, to exert said installation right, in particular to install its application on the smart card, can be transferred from at least one first party or first unit, in particular from the issuer of the smart card, to at least one second party or second unit.

2. The management system according to claim 1, characterized in
that the installation right being supported is
dependent on the application and/or
independent of the application and/or
that the installation right is implemented or at least represented on the smart card in the form of at least one digital certificate, in particular provided by the first party or first unit, and
that the management system is designed to manage said digital certificate.

3. The management system according to claim 1, characterized in that the role of application management is transferred from the first party or first unit to the second party or second unit as soon as at least one management enabling application is installed onto the smart card by said second party or second unit.

4. The management system according to claim 3, characterized by at least one application slot wherein the management system is designed to enforce that at least one public key of the second party or second unit is used to verify the installation right as soon as the management enabling application is installed.

5. The management system according to claim 3 4, characterized in that the role of application management falls back from the second party or second unit to the first party or first unit as soon as the management enabling application is deleted and/or uninstalled.

6. The management system according to claim 1, characterized in that the second party or second unit
is a payment organization adopting the role of application management after at least one payment application is installed as management enabling application on the smart card and/or
can identify which other application(s) is (are) already present on the smart card and/or
is allowed to check at least one respective application code of other application(s) already available on the smart card and/or
can initiate at least one delete request for application(s) already present on the smart card.

7. The management system according to claim 1, characterized in that the first party or first unit and/or the second party or second unit and/or the third party or third unit and/or at least one further party or further unit is allowed to delete and/or to uninstall at least one application being present on the smart card wherein this action of deleting and/or of uninstalling has to be confirmed by the user.

8. The management system according to claim 1, characterized in that any change of the smart card, in particular any installation or deletion taking place on the smart card, needs to be confirmed by the user of the smart card, wherein the confirmation by the user is in particular enforced by the management system.

9. The management system according to claim 8, characterized in
that the management system sends at least one confirmation request via at least one host terminal and
that the confirmation request has to be confirmed by the user of the smart card, wherein the confirmation request can be confirmed
by pressing at least one button on the host terminal or
by completing at least one cardholder verification process, in particular
by entering at least one P[ersonal]l[dentification]N[umber] and/or
by identifying via at least one biometric feature.

10. Integrated circuit, characterized by at least one management system according to claim 1.

11. Smart card, in particular multi-application smart card, characterized by at least one integrated circuit according to claim 10.

12. A method for managing at least one installation right to install at least one application on a smart card, in particular on a multi-application smart card, characterized in that said installation right is managed insofar as the role of authorizing at least one third party or third unit, in particular at least one third party application provider, to exert said installation right, in particular to install its application on the smart card, can be transferred from at least one first party or first unit, in particular from the issuer of the smart card, to at least one second party or second unit.

13. Use of at least one management system according to claim 1 and/or of at least one integrated circuit and/or of the method for flexible and transferable application management on a multi-application smart card.
